(19) United States
(12) Patent Application Publication
(10) Pub. No.: US 2006/0001320 A1
(43) Pub. Date: Jan. 5, 2006

(54) Power supply trouble detecting apparatus and electronic circuit

(75) Inventor: Tetsuhiko Ichihashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/971,088

(22) Filed: Oct. 25, 2004

(30) Foreign Application Priority Data
Jul. 5, 2004 (JP) 2004-197630

(51) Int. Cl. H02J 1/10

(52) U.S. Cl. 307/43

(57) ABSTRACT

The object of the present invention is to provide a power source trouble detecting apparatus having provided an OR-circuit which can take logical addition of trouble detecting signals and generate an alarm signal when the trouble detecting signal is sent out from at least one of the power source modules. With this arrangement, the trouble of the power source modules can be promptly detected and influence upon other units can be suppressed to a minimum level.

### BACKGROUND OF THE INVENTION

(1) Field of the Invention

The present invention relates to technology for detecting trouble brought about in a power supply module.

(2) Description of Related Art

Recently, a scheme comes to known in a field of power supply for electric components. That is, such that a plurality of power supply modules are driven in parallel for supplying a predetermined level of electric power to electronic components such as an LSI (Large Scale Integration) mounted on a circuit board (unit). One of such examples is that if the LSI requires an electric power at a level of 20 A (ampere) a couple of DDC modules (DC-DC converter modules) each capable of supplying an electric power at a level of 10 A are prepared and driven in parallel for supplying the electric power at a level of 20 A to the LSI.

When the above-described power supply scheme is employed, if at least one of the plural DDC modules driven in parallel suffers a trouble, sufficient electric power is failed to be supplied to the LSI (load). As a result, a voltage to be applied to the LSI is lowered and the LSI becomes incapable of being operated. At this time, the voltage tends to be lowered, and the LSI operation cannot be ensured.

If the above-described unit is assembled into an electronic apparatus together with other units and the LSI is connected to other units so that communication can be established therebetween, the LSI could send an abnormal signal (undesired signal) due to the voltage decrease and this abnormal signal can cause a negative influence upon other units or the whole of the apparatus.

In order to minimize the influence upon other units or the apparatus caused by the power supply module trouble, it is requested to swiftly detect the trouble on the power supply module and reliably prevent the abnormal signal from being propagated to other units.

According to a conventional method, detection is made on the voltage decrease of an electric power supplied from the power supply module so that a trouble brought about in the power supply module is detected.

FIG. 3 is a diagram schematically showing an arrangement of an electronic circuit which realizes the conventional scheme of the power supply trouble detection.

As shown in FIG. 3, this electronic circuit includes a couple of DDC modules 10a and 10b, voltage decrease detecting unit 11, a bus control unit 12 and an LSI 13. Electric power supplied from the couple of DDC modules 10a and 10b is fed to the LSI 13 through power supply lines not shown.

The LSI 13 is driven by electric power supplied from the DDC modules 10a and 10b and carries out various kinds of processing.

The LSI 13 is connected to other units (not shown) through a bus 15a and a bus 15b so that communication can be established therebetween. The bus control unit 12 includes a switch 14 which can connect the bus 15a connected to the bus 15a and the bus 15b connected to other units to each other or disconnect the same from each other. The switch 14 is controlled in the status of connection and disconnection, whereby the LSI 13 and other units are controlled in the status of connection and disconnection therebetween. In more concretely, when the bus control unit 12 receives a bus disconnection instructing signal from the voltage decrease detecting circuit 11, the bus control circuit 12 controls the switch 14 to disconnect between the LSI 13 and other units.

The voltage decrease detecting unit 11 is arranged to detect voltage lowering in electric power supplied from the DDC modules 10a and 10b. That is, the voltage decrease detecting unit 11 responds to the detection of the voltage decrease so that the bus disconnection instructing signal is delivered to the bus control unit 12.

FIG. 4 is a timing chart illustrating how the voltage decrease detecting unit 11 of the conventional power supply trouble detecting apparatus detects a trouble in the DDC modules 10a and 10b.

The voltage decrease detecting unit 11 has set therein a threshold value (voltage decrease detecting value) in advance for detecting whether a trouble is brought about in the DDC modules 10a and 10b or not. The voltage decrease detecting value is set to a value higher than the lower limit of voltage allowing the LSI 13 to be operated.

The voltage decrease detecting unit 11 compares the voltage of the electric power supplied from the DDC modules 10a and 10b with the voltage decrease detecting value. When it is detected that the electric power supplied from the DDC modules 10a and 10b becomes smaller than the voltage decrease detecting value, the bus disconnection instructing signal is delivered to the bus control unit 12.

As described above, according to the electronic circuit provided in the conventional power supply trouble detecting apparatus, the voltage decrease detecting unit 11 examines the voltage of the electric power supplied from the DDC modules 10a and 10b. When it is detected that the electric power supplied from the DDC modules 10a and 10b becomes smaller than the voltage decrease detecting value, the bus disconnection instructing signal is delivered to the bus control unit 12. When the bus control unit 12 receives the bus disconnection instructing signal, the bus control unit 12 responds to the signal to bring about the disconnection status at the buses 15a and 15b which have connected the LSI 13 and other units to each other.

In this way, if the trouble is brought about by any cause in the DDC module 10a or 10b and voltage decrease is brought about in the supplied electric power thereof, the LSI 13 will operate erroneously due to the voltage lowering and any kind of the abnormal signal can be generated from the LSI 13. However, such abnormal signal can be prevented from being propagated to other units.

[Patent Document 1] Japanese Patent Laid-open No. HEI3-103071

However, the detection scheme of the above-described conventional power supply trouble will encounter a problem that it is hard to set the voltage decrease detecting value to the power supply trouble detecting apparatus.

As shown in FIG. 4, when the voltage decrease is brought about in the electric power from the DDC modules 10a and 10b, it takes a certain period of time (bus disconnection required time) from a timing point when the voltage decrease detecting unit 11 detects that the supplied electric power becomes smaller than the voltage lowering detecting value (i.e., a timing point of detecting the trouble) to a timing point when the bus disconnection is accomplished by the bus control unit 12. Therefore, if it is requested to ensure that the bus disconnection is accomplished before the LSI 13 operates erroneously due to the supplied voltage decrease and any abnormal signal is generated from the LSI 13 and that the abnormal signal is prevented from being propagated to other units, then the voltage decrease detecting value is necessary to be set to a value under consideration of the bus disconnection required time.

That is, the voltage decrease detecting value is set to a value slightly higher than the lower limit of voltage allowing the LSI 13 to be operated. However, if the voltage lowering detecting value is set to a value excessively close to the lower limit of voltage which allows the LSI 13 to be operated, there is a fear that the bus disconnection can be performed after the supplied voltage becomes lower than the lower limit of voltage allowing the operation of the LSI 13. Conversely, if the voltage decrease detecting value is set to a value excessively far away from the lower limit of voltage allowing the operation of the LSI 13, the bus control unit can be excessively sensible in performing bus disconnection in response to a voltage fluctuation caused within a range of normal operation of the DDC modules 10a and 10b. Also, it is necessary to take into account the fluctuation in the signal propagation delay inherently possessed by the power supply trouble detecting circuit itself.

### SUMMARY OF THE INVENTION

The present invention seeks to solve the above-described problems. To this end, there is provided a power supply trouble detecting apparatus including an OR-circuit for taking logical addition of trouble detecting signals capable of being sent out from a plurality of power supply modules, respectively, then generating an alarm signal in response to the trouble detecting signal which is sent out from at least one of the plurality of power supply modules.

Further, according to the present invention, there is provided an electronic circuit including an electronic component capable of being driven by electric power supplied by a plurality of power supply modules, a control unit capable of controlling connection/disconnection between the electronic component and an external device which is connectable to the electronic component to establish communication therebetween, an OR-circuit for taking logical addition of trouble detecting signals capable of being sent out from the plurality of power supply modules, respectively, then generating a disconnection instructing signal to the control unit in response to the trouble detecting signal which is sent out from at least one of the plurality of power supply modules, wherein the control unit cuts the connection between the electronic component and the external device upon receiving the disconnection instructing signal.

Furthermore, according to the present invention, there is provided an electronic circuit including an electronic component connectable to an external device to establish communication therebetween, a plurality of power supply modules capable of supplying electric power to the electronic component, a control unit capable of controlling connection/disconnection between the electronic component and the external device, an OR-circuit for taking logical addition of trouble detecting signals capable of being sent out from the plurality of power supply modules, respectively, then generating a disconnection instructing signal to the control unit in response to the trouble detecting signal which is sent out from at least one of the plurality of power supply modules, wherein the control unit cuts the connection between the electronic component and the external device upon receiving the disconnection instructing signal.

According to the present invention, the trouble in the power supply module can be promptly detected, an alarm signal can be generated, and influence upon other units can be suppressed to the minimum level. Moreover, since voltage decrease in the electric power supplied from the power supply modules need not be detected, it becomes unnecessary to set an electric power decrease detecting value which requires a complicated process.

### BRIEF DESCRIPTION OF THE DRAWINGS

FIG. 1 is a diagram schematically showing an arrangement of an electronic circuit as one embodiment of the present invention;

FIG. 2 is a diagram illustrating a timing of detecting a trouble by the electronic circuit as one embodiment of the present invention;

FIG. 3 is a diagram schematically showing an arrangement of an electronic circuit realizing a conventional scheme of power supply trouble detection; and

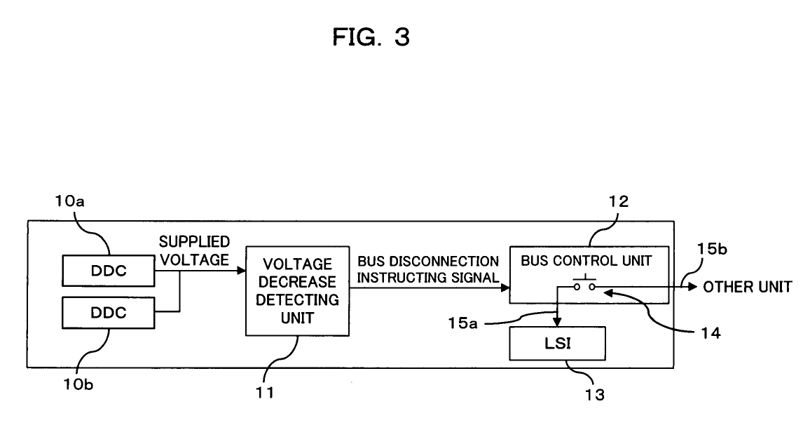

FIG. 4 is a diagram illustrating a timing of detecting a trouble by a voltage decrease detecting unit of a conventional power supply trouble detecting apparatus.

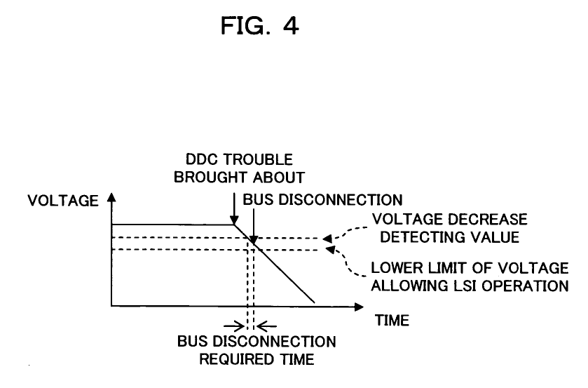

### DESCRIPTION OF THE PREFERRED EMBODIMENTS

An embodiment of the resent invention will be hereinafter described with reference to drawings.

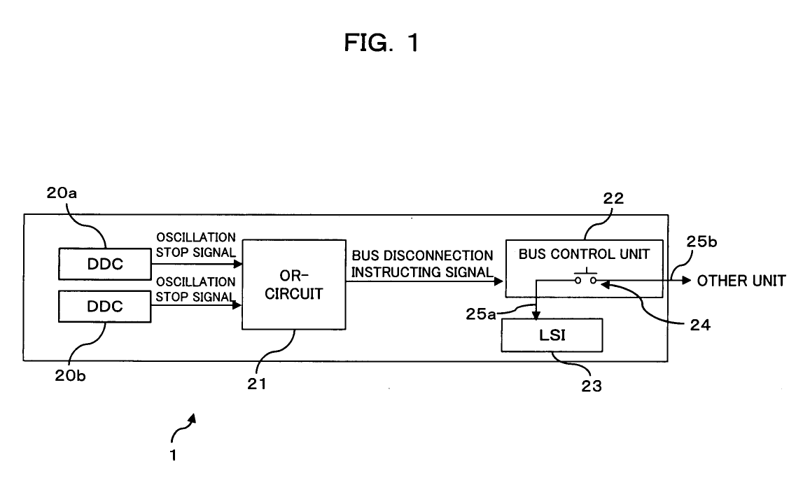

FIG. 1 is a diagram schematically showing an arrangement of an electronic circuit as one embodiment of the present invention.

An electronic circuit 1 shown in FIG. 1 is provided with a power supply trouble detecting function. This electronic circuit 1 is arranged to include a couple of DDC modules (DC-DC converter; power supply modules) 20a and 20b, an OR-circuit 21, a bus control unit 22 and an LSI 23. Electric power supplied from the couple of DDC modules 20a and 20b is fed to the LSI 23 through power supply lines not shown.

The DDC modules (power supply modules) 20a and 20b are units for supplying electric power to the LSI 23 or the like. The electronic circuit 1 comprises a plurality of (in the present case, a couple of) DDC modules 20a and 20b. These plural number of DDC modules 20a and 20b can be driven in parallel to serve as a parallel driven power source.

Each of the DDC modules 20a and 20b are arranged to generate a trouble detecting signal when any trouble is brought about. The generated trouble detecting signals are supplied to the OR-circuit 21 at its input pins, respectively. Each of the trouble detecting signals is promptly outputted when at least one of the DDC modules 20a and 20b suffers from trouble or the like and the operation thereof is stopped.

In the present embodiment, each of the DDC modules 20a and 20b is arranged to generate an oscillation stop signal when an FET or the like provided therein suffers malfunction. That is, the oscillation stop signal functions as the trouble detecting signal. Now, description will be hereinafter made on an example in which each of the DDC modules 20a and 20b generates the oscillation stop signal as the trouble detecting signal.

The OR-circuit 21 takes a logical addition of the oscillation stop signals which can be sent from the DDC modules 20a and 20b. The OR-circuit 21 generates a bus disconnection instructing signal (connection cut instructing signal or alarm signal) when at least one of the plural DDC units 20a and 20b sends the oscillation stop signal. The bus disconnection instructing signal generated from the OR-circuit 21 is inputted into the bus control unit 22. That is, in the present electronic circuit 1, the OR-circuit 21 detects the trouble detecting signal sent from the DDC modules 20a and 20b in terms of hardware and delivers bus disconnection instruction to the bus control unit 22.

The LSI (electronic component) 23 is driven by electric power supplied from the DDC modules 20a and 20b and performs various kinds of processing. The LSI 23 is connected to other units (external units; not shown) through a bus 25a and a bus 25b so that communication can be established therebetween. The bus control unit (control unit) 22 includes a switch 24 which can select connection status and disconnection status between the bus 25a connected to the LSI 23 and the bus 25b connected to the other units. The bus control unit 22 controls the switch 24 in the connection status and disconnection status so that the connection status and disconnection status between the LSI 23 and the other units is controlled.

The bus control unit 22 controls the switch 24 so that the disconnection status between the LSI 23 and other units is brought about when the bus unit 22 receives the bus disconnection instructing signal from the OR-circuit 21.

With the above-described arrangement of the electronic circuit 1 as one embodiment of the present invention, when at least one of the DDC module 20a and DDC module 20b suffers a trouble and operation thereof is stopped, the DDC module 20a and 20b suffering the trouble promptly sends the trouble detecting signal. The trouble detecting signal is supplied to the OR-circuit 21 and the OR-circuit 21 generates the bus disconnection instructing signal to the bus control unit 22 in response to the oscillation stop signal sent out from at least one of the DDC modules 20a and 20b.

When the bus control unit 22 receives the bus disconnection instructing signal from the OR-circuit 21, the bus control unit 22 exerts control on the switch 24 so that the connection between the bus 25a and bus 25b is cut and disconnection status is brought about between the LSI 23 and other units.

As described above, according to the electronic circuit 1 as one embodiment of the present invention, even if voltage decrease is brought about in the supplied electric power due to the trouble in the DDC modules 20a and 20b and the LSI 23 is erroneously operated, an abnormal signal sent out from the LSI 23 can be prevented from being propagated to other units. Therefore, negative influence upon other units or devices can be reliably prevented with ease and manufacturing cost thereof can be decreased.

Furthermore, since it is unnecessary to detect the voltage decrease of the electric power supplied from the DDC modules 20a and 20b, it becomes unnecessary to set an electric power lowering detecting value (voltage value) which requires a complicated process.

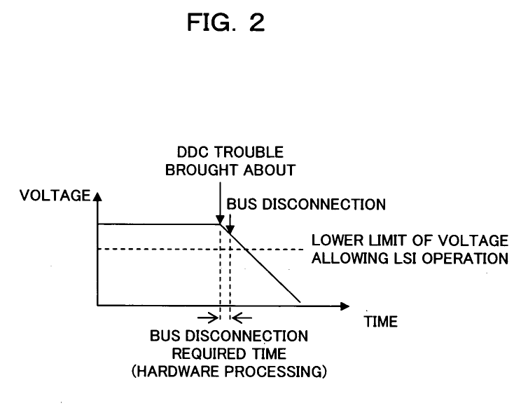

FIG. 2 is a diagram showing a timing of detecting trouble brought about in the DDC modules 20a and 20b provided in the electronic circuit 1 as one embodiment of the present invention.

In the present electronic circuit 1, when any trouble is brought about in the DDC modules 20a and 20b, the oscillation stop signal is generated. If the oscillation stop signal is sent out from at least one of the DDC modules 20a and 20b, the OR-circuit 21 generates the bus disconnection instructing signal. With this manner, as shown in FIG. 2, the timing point when at least one of the DDC modules 20a and 20b suffers a trouble serves as the starting point of the bus disconnection required time. As a consequence, it becomes possible for the bus control unit 22 to disconnect the bus connection before the voltage of the supplied electric power is decreased to a value smaller than the lower limit of the voltage which allows the LSI 23 to be operated.

Furthermore, the OR-circuit 21 detects the trouble detecting signal sent from the DDC modules 20a and 20b and delivers the bus disconnection instruction to the bus control unit 22 based on a hardware manner, and the control unit 22 responds to the bus disconnection instruction to perform the bus disconnection. Therefore, when at least one of the DDC modules 20a and 20b suffers trouble, the bus disconnection can be preformed at a minimum time loss. Accordingly, the reliability of the apparatus is improved.

The present invention is not limited to the above embodiment but various changes and modifications could be effected without departing from the gist of the invention.

For example, while in the above-described embodiment the electronic circuit 1 is arranged to have a couple of power supply module, i.e., the couple of DDC modules 20a and 20b, the arrangement for the electronic circuit is not limited thereto but other arrangement such as one having three or more power supply modules can be employed. In this case, it is desirable for the OR-circuit 21 to be arranged by a combination of a plurality of OR-circuit modules for preparing sufficient number of input pins so that this arrangement can cope with the number of power supply modules and can take logical addition among the trouble detecting signals sent from the three or more power supply modules.

While in the above embodiment the DDC modules 20a and 20b are arranged to generate the oscillation stop signal as the trouble detecting signal when the FET suffers a malfunction, the arrangement therefore is not limited thereto but the DDC modules 20a and 20b may be arranged to generate the trouble detecting signal when any trouble other than the malfunction of the FET is brought about.

Furthermore, while in the above embodiment description has been made on an example having the DDC modules as the power supply modules, the arrangement is not limited thereto but other arrangement such as one having various power supply modules capable of sending the trouble detecting signal (such as AC-DC converter) may be employed.

The present invention can be implemented or manufactured by those skilled in the art based on the disclosure of the respective embodiments of the present invention.

What is claimed is:

1. A power supply trouble detecting apparatus comprising an OR-circuit for taking logical addition of trouble detecting signals capable of being sent out from a plurality of power supply modules, respectively, then generating an alarm signal in response to said trouble detecting signal which is sent out from at least one of said plurality of power supply modules.

2. An electronic circuit comprising:
an electronic component capable of being driven by electric power supplied by a plurality of power supply modules;
a control unit capable of controlling connection/disconnection between said electronic component and an external device which is connectable to said electronic component to establish communication therebetween;
an OR-circuit for taking logical addition of trouble detecting signals capable of being sent out from said plurality of power supply modules, respectively, then generating a disconnection instructing signal to said control unit in response to said trouble detecting signal which is sent out from at least one of said plurality of power supply modules, wherein
said control unit cuts the connection between said electronic component and the external device upon receiving said disconnection instructing signal.

3. An electronic circuit comprising:
an electronic component connectable to an external device to establish communication therebetween;
a plurality of power supply modules capable of supplying electric power to said electronic component;
a control unit capable of controlling connection/disconnection between said electronic component and said external device;
an OR-circuit for taking logical addition of trouble detecting signals capable of being sent out from said plurality of power supply modules, respectively, then generating a disconnection instructing signal to said control unit in response to said trouble detecting signal which is sent out from at least one of said plurality of power supply modules, wherein
said control unit cuts the connection between said electronic component and the external device upon receiving said disconnection instructing signal.
